(19) United States
(12) Patent Application Publication
(10) Pub. No.: US 2014/0006541 A1
(43) Pub. Date: Jan. 2, 2014

(54) PERSISTENT MESSAGING

(71) Applicant: INTERNATIONAL BUSINESS MACHINES CORPORATION, (US)

(72) Inventors: William BITTLES, Hursley (GB); David GRANSHAW, Hursley (GB)

(73) Assignee: INTERNATIONAL BUSINESS MACHINES CORPORATION, Armonk, NY (US)

(21) Appl. No.: 13/873,687

(22) Filed: Apr. 30, 2013

(30) Foreign Application Priority Data
Jun. 28, 2012 (GB) 1211447.6

(51) Int. Cl. G06F 3/06

(52) U.S. Cl. CPC G06F 3/067; G06F 3/0614; G06F 3/0643
USPC 709/213

(57) ABSTRACT

A message is written into a shared memory location in a distributed file system by a message producer. An associated message reference is written into a message queue. The associated message reference points to the shared memory location. The associated message reference is read from the message queue by the remote message consumer and the message is accessed in the distributed file system on receiving a notification of the associated message reference in the message queue.

### PRIORITY CLAIM

This application claims priority to GB Patent Application No. GB1211447.6, filed Jun. 28, 2012, which is hereby incorporated by reference in its entirety.

### BACKGROUND OF THE INVENTION

1. Field of the Invention

The present invention relates in general to computers, and more particularly to managing persistent messages between a message producer and a remote message consumer in a computing environment.

2. Description of the Related Art

With currently available technology, persistent messages are typically handled in the following way. A messaging producer sends the message to a messaging engine by use of a client stub, such as the Java Messaging Service (JMS), typically over a computer network, using an Internet protocol such as TCP. The messaging engine then persists the message by writing it to storage, such as a disk system. In a simple case, the messaging engine then reads the message from the disk and sends it again over the network, to a message consumer, which consumes the message via a stub such as JMS. When this process is complete, the messaging engine then deletes the original message. Such a process is usually processed under a transaction system to allow for backing out in the event of failure. With serialization, the reading, writing and transmission of the message data takes some time and there is scope for improvement. (Java is a trademark of Oracle Corporation in the US and/or other countries.)

### SUMMARY OF THE DESCRIBED EMBODIMENTS

In one embodiment, a method is provided for managing persistent messages between a message producer and a remote message consumer in a computing environment using at least one processor device. In one embodiment, by way of example only, the method writes a message into a shared memory location in a distributed file system by a message producer. An associated message reference is written into a message queue. The associated message reference points to the shared memory location. The associated message reference reads from the message queue by the remote message consumer and the message accesses in the distributed file system on receiving a notification of the associated message reference in the message queue.

In another embodiment, a computer system is provided managing persistent messages between a message producer and a remote message consumer in a computing environment. The computer system includes a computer-readable medium and at least one processor in operable communication with the computer-readable medium. In one embodiment, by way of example only, at least one of the processors writes a message into a shared memory location in a distributed file system by a message producer. An associated message reference is written into a message queue. The associated message reference points to the shared memory location. The associated message reference reads from the message queue by the remote message consumer and the message accesses in the distributed file system on receiving a notification of the associated message reference in the message queue.

In a further embodiment, a computer program product is provided for managing persistent messages between a message producer and a remote message consumer in a computing environment using at least one processor device. The computer-readable storage medium has computer-readable program code portions stored thereon. The computer-readable program code portions include a first executable portion that writes a message into a shared memory location in a distributed file system by a message producer. An associated message reference is written into a message queue. The associated message reference points to the shared memory location. The associated message reference reads from the message queue by the remote message consumer and the message accesses in the distributed file system on receiving a notification of the associated message reference in the message queue.

In a first aspect of the invention there is provided a method for managing persistent messages in a system of message producers, message consumers and message queues as claimed in claim 1.

A persistent message is a message that has durability such that it may be recovered in the event of a system shut down or failure. Shared memory can be shared memory on a disk or shared cache memory or any shared memory.

The embodiments relate to messaging systems wherein messages are transferred using a queue manager, where producers and consumers share a storage area network (SAN). The embodiments rely on a distributed file system that is presented by the SAN for returning a reference to a persisted message. In the preferred embodiment, the length of the write is returned. In other embodiments the file system returns contiguous extents for a single write but in reality multiple extents could be returned if the extents were not contiguous.

The embodiments are an improvement over known techniques for processing persistent messages, greatly improving the performance characteristics. The embodiments use the features of a storage area network (SAN) and a distributed file systems to greatly improve the speed of processing persistent messages whilst reducing the use of scarce computing resources such as disks and network bandwidth. Previously distributed file systems would be too slow in responding to provide a reliable message data handling but the embodiments realizes that reliability and speed developments in SAN technology have allowed new ways to process messages.

As two messaging entities are sharing the same file system, the embodiments propose that a messaging producer only sends the starting extent and length of the message to the target messaging provider. This greatly reduces the amount of data that needs to be transmitted across the network, and completely eliminates a disk write and delete, whilst maintaining data and transactional integrity.

Greater improvements are realized when the workload is scaled up and with increased message size. A more subtle improvement can be gained when the number of producers is increased because the complexity of the transaction logging is reduced. Transaction logging becomes almost trivial from the messaging engine perspective and avoids potential synchronization bottlenecks in the transactional log. In event of a failure there is no need to rebuild complex transaction logs and only the file references are recovered.

In a second aspect of the invention there is provided a method for managing persistent messages in a producer as claimed in claim 6.

In a third aspect of the invention there is provided a system for managing persistent messages as described in claim 11.

In a fourth aspect of the invention there is provided a computer program product as described in claim 15.

In a fifth aspect of the invention there is provided a computer program as described in claim 16

In addition to the foregoing exemplary method embodiment, other exemplary system and computer product embodiments are provided and supply related advantages. The foregoing summary has been provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict embodiments of the invention and are not therefore to be considered to be limiting of its scope, the invention will be described and explained with additional specificity and detail through the use of the accompanying drawings, in which:

FIG. 1 shows applications at run time using messaging platforms;

FIG. 2 shows preferred embodiment messaging platforms deployed in a distributed file system;

FIG. 3 is a flow diagram of the global messaging method of the preferred embodiment; and

FIG. 4A to 4G are state diagrams showing an example message transfer of the preferred embodiment.

### DETAILED DESCRIPTION OF THE DRAWINGS

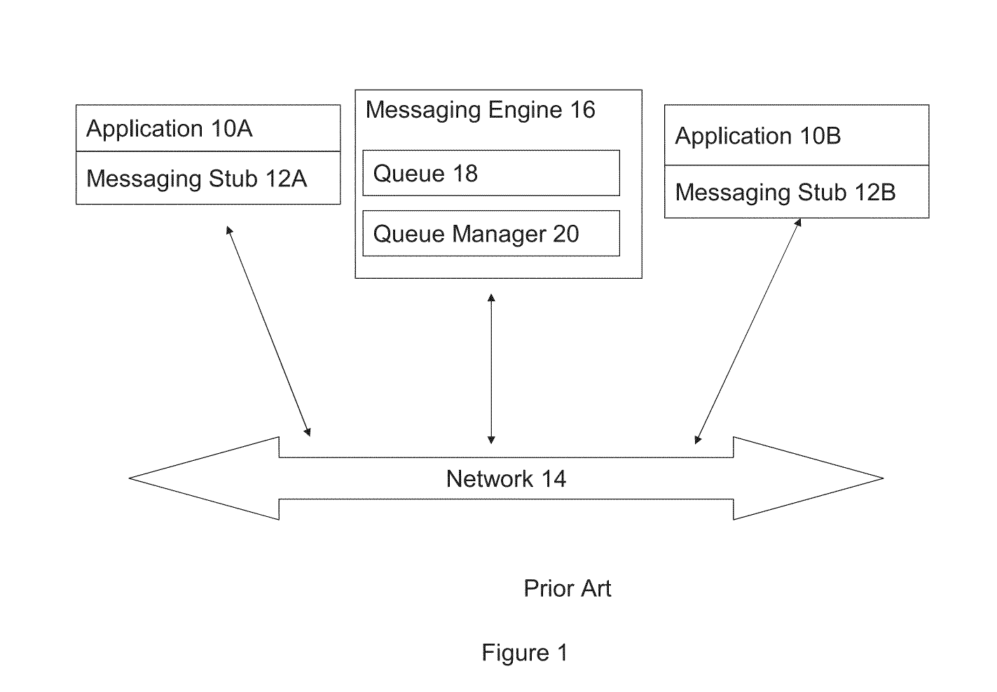

The preferred embodiment of the invention extends a messaging platform such as the Java Messaging System (JMS) or IBM® MQSeries and such a platform is described with reference to FIG. 1 as background to the embodiments. A messaging platform enables programs to communicate with each other across a network of unlike components, such as processors, subsystems, operating systems and communication protocols. A messaging platform uses a consistent application program interface (API) across all operating system and machine platforms to enable interoperability. Referring to FIG. 1, two applications 10A and 10B are executing and passing messages to one another using a messaging platform. Applications use messaging API calls via messaging stubs 12A and 12B to communicate with a messaging engine 16 via a network 14. Messaging engine 16 comprises a queue 18 and a queue manager 20. (IBM® and MQSeries are trademarks of International Business Machines Corporation in the United States and/or other countries.)

Message queuing is a method of program-to-program communication. An application communicates by writing and retrieving application-specific data (messages) to/from queues, without having a private, dedicated, logical connection to link them. Messaging means that applications communicate with each other by sending data in messages and not by calling each other directly. Queuing means that applications communicate through queues. Applications communicating through queues need not be executed concurrently.

With asynchronous messaging, a producer application proceeds with its own processing without waiting for a reply to its message. In contrast, synchronous messaging waits for the reply before resuming processing. For the user, the underlying protocol is transparent. The user is concerned with conversational or data-entry type applications. The messaging platform of the preferred embodiment is used in a client/server or distributed environment. Programs belonging to an application can run in one workstation or in different machines on different platforms. Applications can easily be moved from one operating system or hardware platform to another.

The programmer does not have to worry about the target program being busy or not available and is not concerned about the server being down or having no connection to it. The application sends messages to a queue that is associated with an application; and the application may or may not be available at the time of the request. The messaging engine takes care of the transport to the target application and even starts it, if necessary. If the target application is not available, the messages stay in a queue and get processed later. The queue can be in the sending machine, target machine or a third party machine such as an independent server. Applications can be running all day long or they can be triggered, that is, automatically started when a message arrives or after a specified number of messages have arrived.

A message consists of parts including: data that is sent from one program to another; and the message descriptor or message header. The message descriptor identifies the message (message ID) and contains control information, also called attributes, such as message type, expiry time, correlation ID, priority, and the name of the queue for the reply. Messages are typically less than 4 MB but may be 100 MB or more.

Application design determines whether a message must reach its destination under any circumstances, or if it can be discarded when it cannot get there in time. Delivery of persistent messages is assured; they are written to logs to survive system failures. Non-persistent messages cannot be recovered after a system restart.

The heart of a messaging engine 16 is queue manager 20 for managing the queue 18 and messages for applications. It provides the interface for communication with applications via the messaging stubs. Application programs invoke functions of the queue manager by issuing API calls. For example, a ‘PUT’ API call puts a message on a queue to be read by another program using the ‘GET’ API call.

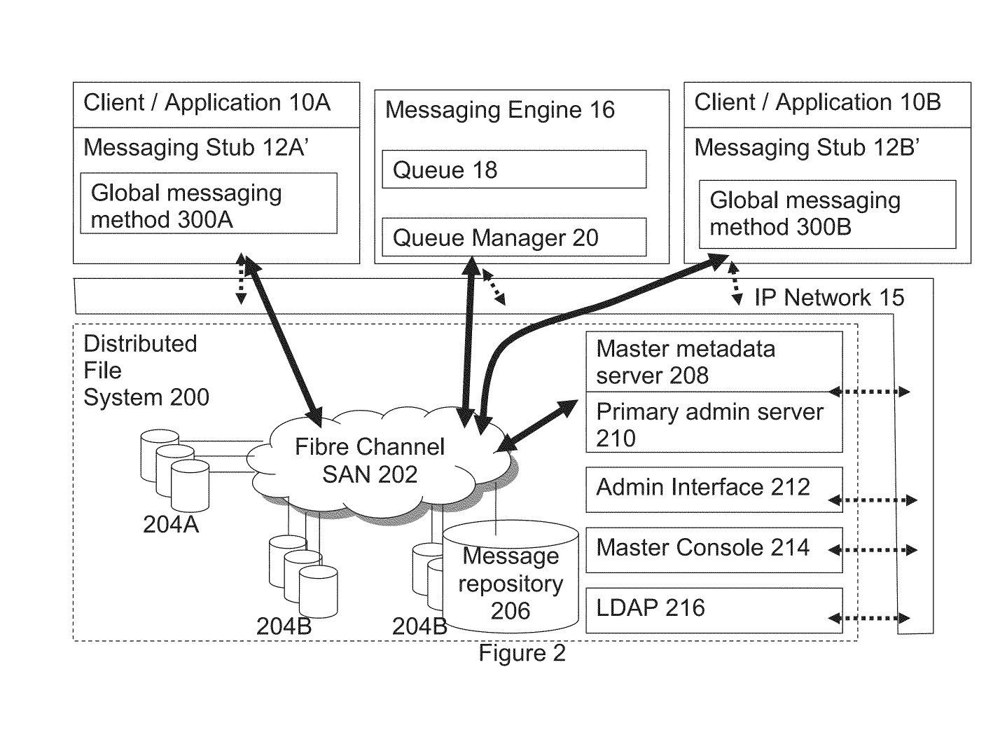

The preferred embodiment is a messaging system deployed in a distributed file system. Referring to FIG. 2, an example of two applications 10A, 10B and corresponding messaging stubs 12A′, 12B′ utilizing a distributed file system 200. Messaging stubs 12A and 12B comprise global messaging methods 300A and 300B respectively; a corresponding generic global messaging method 300 is described in more detail further on in the description. Messaging engine 16 comprises: queue 18 and queue manager 20.

Distributed file system 200 comprises: a fibre channel storage area network (SAN) 202; storage pools 204A and 204B; message repository 206; metadata server 208; administration server 210; administration interface 212, master console 214 and an optional lightweight directory access protocol server (LDAP) 216. SAN technology allows an enterprise to connect a large number of heterogeneous computers and share a large number of heterogeneous storage devices over a high-performance network.

Application 10A, application 10B and messaging engine 16 connect directly to the fibre channel SAN 202 as client devices. In the present embodiment application 10A, application 10B and messaging engine 16 connect to an IP network 15 as do the control and administration components of the distributed file system. Two separate networks, one normal, one fast, are a particular feature of the preferred embodiment but other embodiments could use a single fast and reliable network.

Fibre channel SAN 202 provides the physical transport access to the storage pools 204A and 204N using fibre optics to provide fast transfer times. Storage pools 204A and 204B are collections of file system volumes in the SAN and comprise storage disk arrays of various configurations including large, high-performance, high-function storage systems but also any client device storage (storage on the machines that store applications 10A, 10B and messaging engine 16 that can be part of the SAN network). In the distributed file system, clients can access shared data directly from any disk array in the storage pool. Two types of storage pool exist: a system storage pool 204A and a user storage pool 204B. The system storage pool 204A contains the system metadata (such as system configuration and state information) and file metadata (such as file creation date and permissions). The actual file data is stored on the user storage pools 204B.

The SAN distributed file system differs from conventional distributed file systems in that it uses a data-access model that separates file metadata (information about the files, such as owner, permissions, and the physical file location) from actual file data (contents of the files). The metadata is provided to clients by metadata server 208. Clients communicate with the metadata server 208 only to get the information they need to locate and access the files. Once they have this information, SAN clients such as messaging stub 12A′ can access data directly from the storage devices through the clients' own direct connection to the SAN. Direct data access eliminates server bottlenecks and provides the performance necessary for data-intensive applications.

The distributed file system presents a single, uniform, global namespace view of all files in the system to all of the clients, without manual, client-by-client configuration by the administrator. A file can be identified using the same path and file name, regardless of the client platform from which it is being accessed. The global namespace shared directly by clients also reduces the requirement of data replication. As a result, the productivity of the administrator as well as the users accessing the data is improved.

Metadata server 208 and clients communicate over private IP network 15 (see dotted connection arrows) but access data over the fibre channel SAN 202 (see thick solid connection arrows). Metadata server 208 runs on a separate physical machine and performs metadata, administrative, and storage-management services including supplying a reference address when a message is stored in a message repository. Two or more metadata servers may be clustered for scalability and availability, and are referred to collectively as the cluster. In a cluster, there is one master metadata server and one or more subordinate metadata servers. The metadata resides on the system storage pool 204A.

Administrative server 210 allows the distributed file system to be remotely monitored and controlled through a Web-based master console 214. In addition, administrative server 210 processes requests issued from the administrative interface 212. Administrative server 210 runs on the same platform as metadata server 208. It receives all requests issued by administrators and also communicates with the administrative servers that run on each additional metadata server in the cluster to perform routine requests.

Client computers including the computers hosting application 10A, 10B and messaging data 16 share data and have their storage centrally managed by SAN File System. A client can access a single, uniform global namespace through a virtual or installable file system. These clients can act as servers to a broader clientele, providing network file system (NFS) or common Internet file system (CIFS) access to the global namespace or hosting applications, such as database servers or Web-hosting services that use multiple servers.

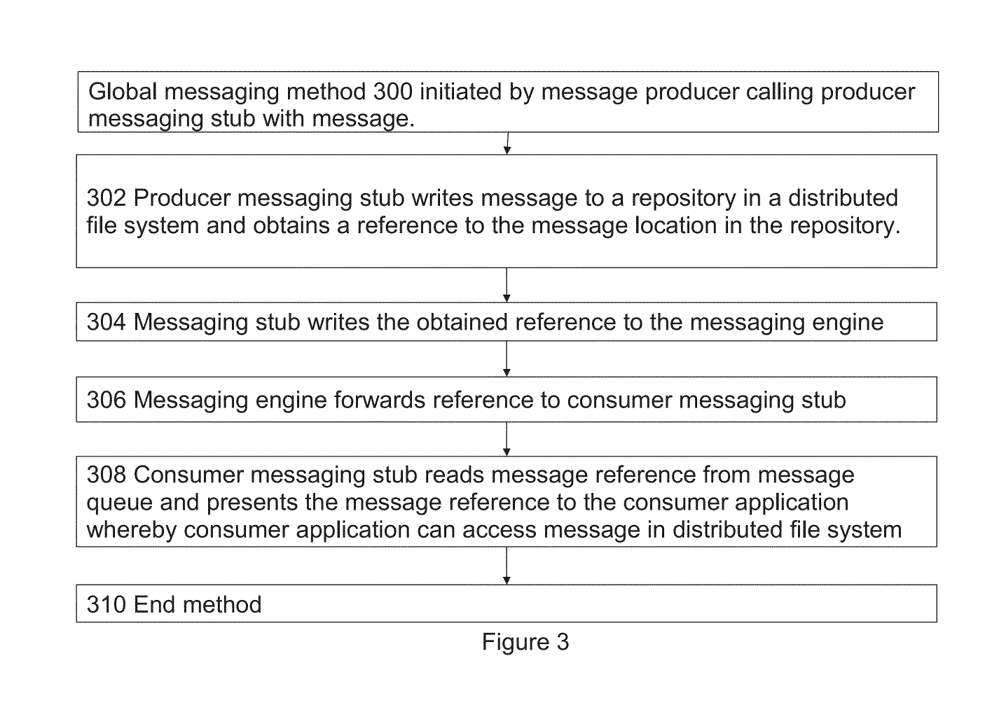

Master console 214 provides serviceability features, including the remote-support interface for remote access and service alert for call home capabilities. Lightweight Directory Access Protocol (LDAP) server 216 is used by the administrative servers to look up authentication and authorization information about the administrative users. Global messaging method 300 of the present embodiment of the invention comprises logical process steps 302 to 310 as described with reference to FIG. 3. Global messaging method 300 is initiated by: a producer application making a ‘PUT’ call to the producer messaging stub in respect of a message that is intended to be sent to a message consumer.

Step 302 is for the producer messaging stub to write a message to repository 206 in distributed file system 300 and obtain a reference. In the present embodiment the reference is created transparently by master metadata server 208 and served back to the messaging stub. Step 304 is for the producer messaging stub to write a reference to the messaging engine.

Step 306 is for the messaging engine to forward the reference on to a consumer application stub. In the preferred embodiment the messaging engine sends the complete reference to the consumer as soon as possible and deletes the reference when the consumer has acknowledged receipt. This is possible in the preferred embodiment of the invention since the reference is much smaller than the message and can be used as a form or wake up or ready signal. In an asynchronous embodiment the messaging engine sends a wake up signal to the consumer; the consumer will request the message; and messaging engine will send a message reference.

Step 308 is for the consumer messaging stub to read the message reference and present the message reference to the consumer application whereby consumer application can access message in distributed file. Step 310 is the end of global messaging method 300.

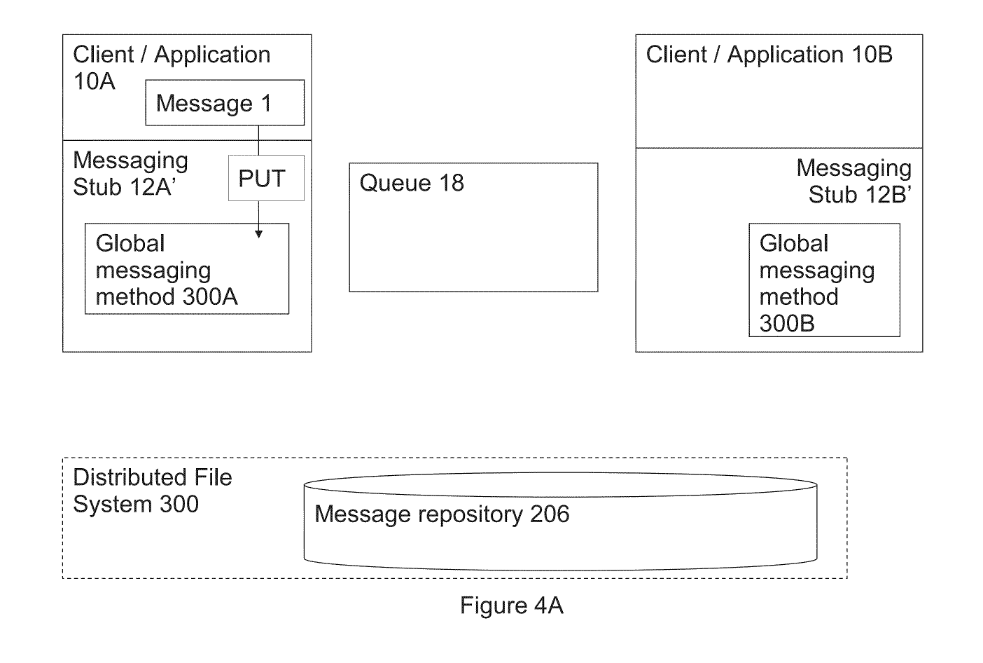

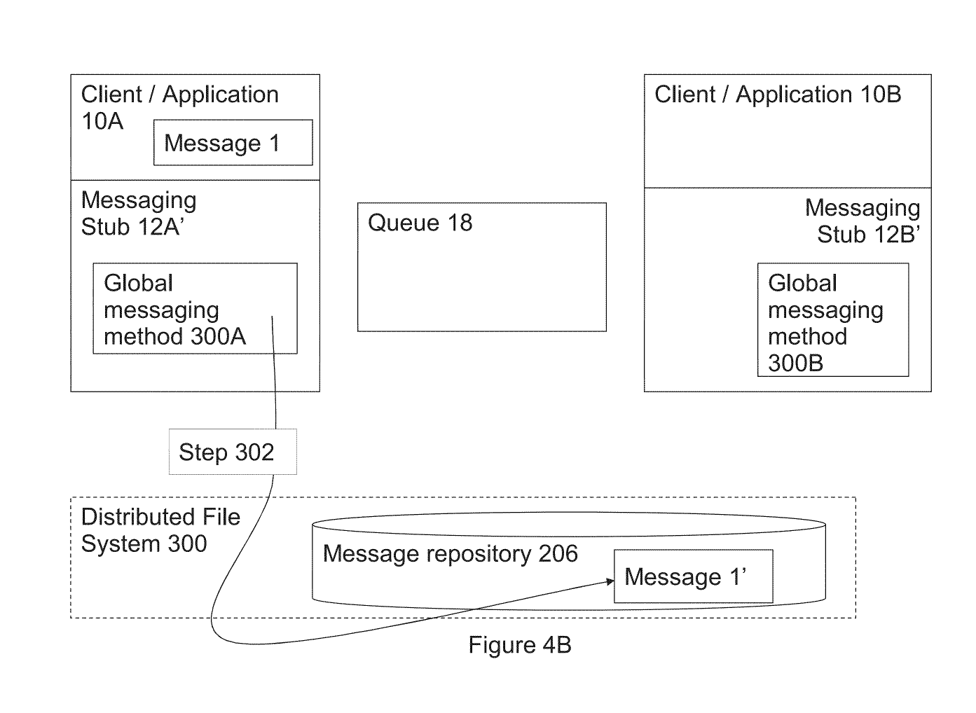

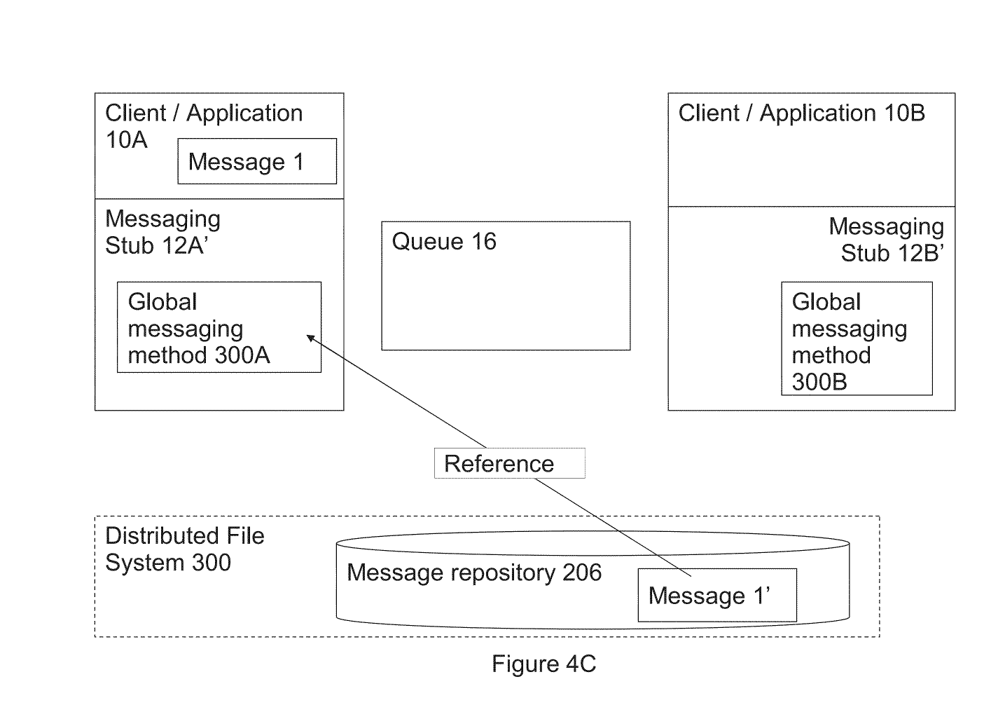

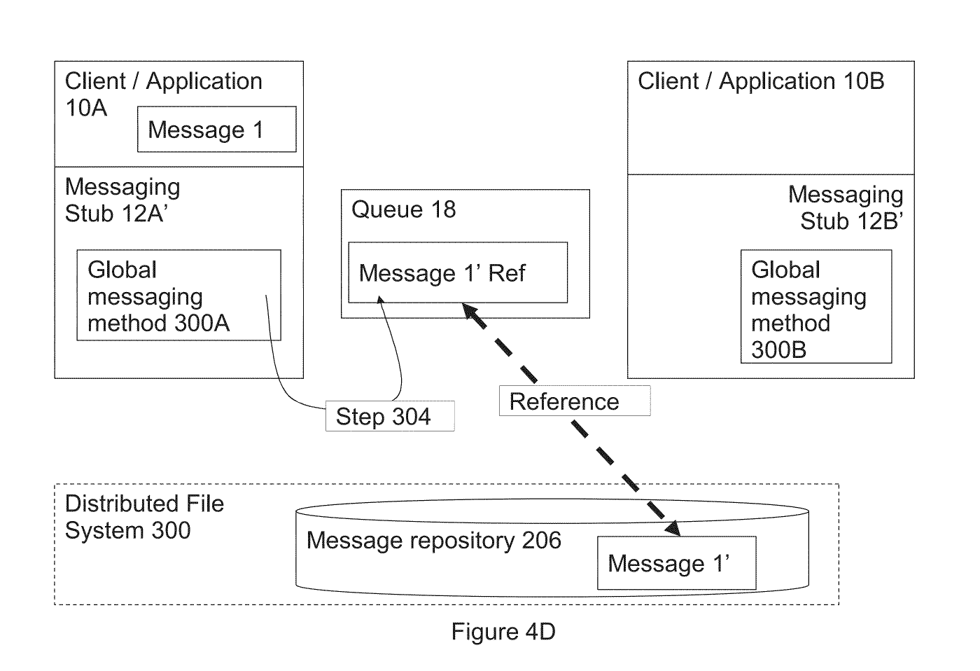

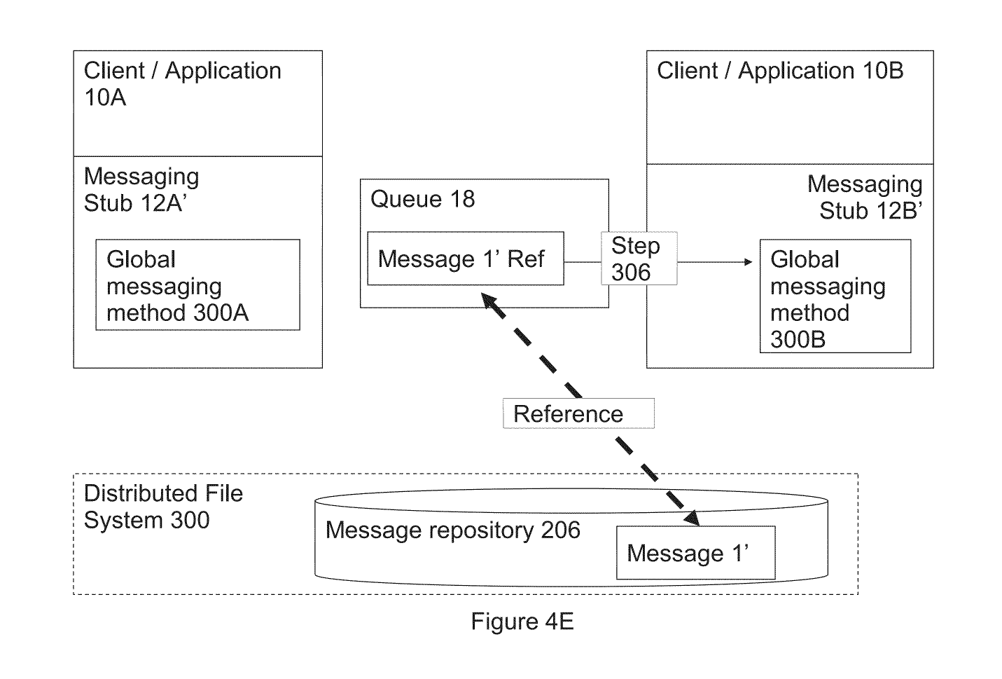

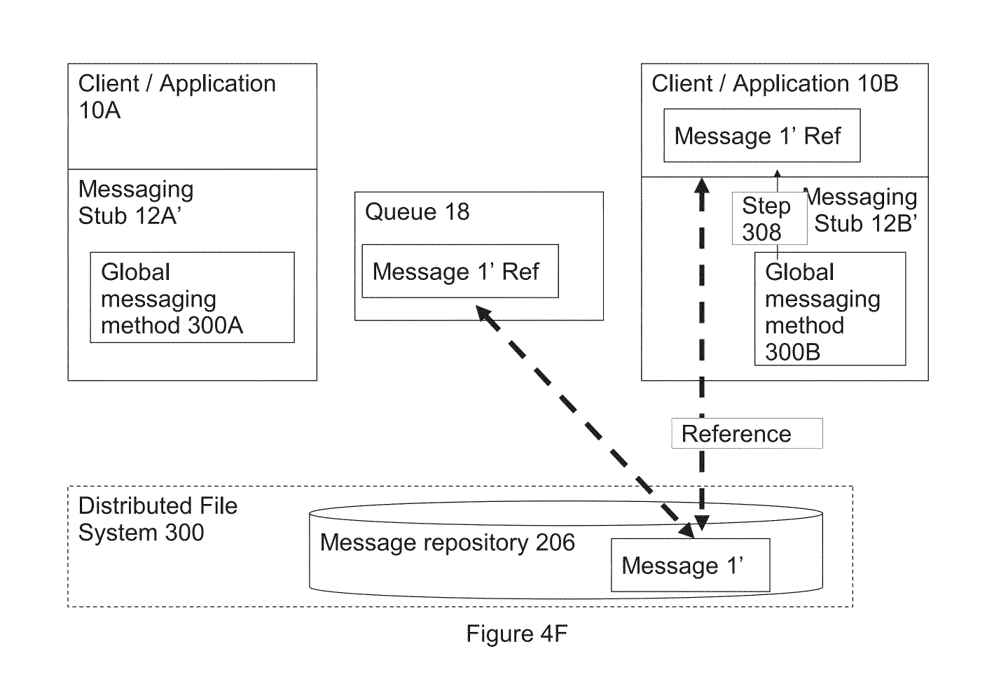

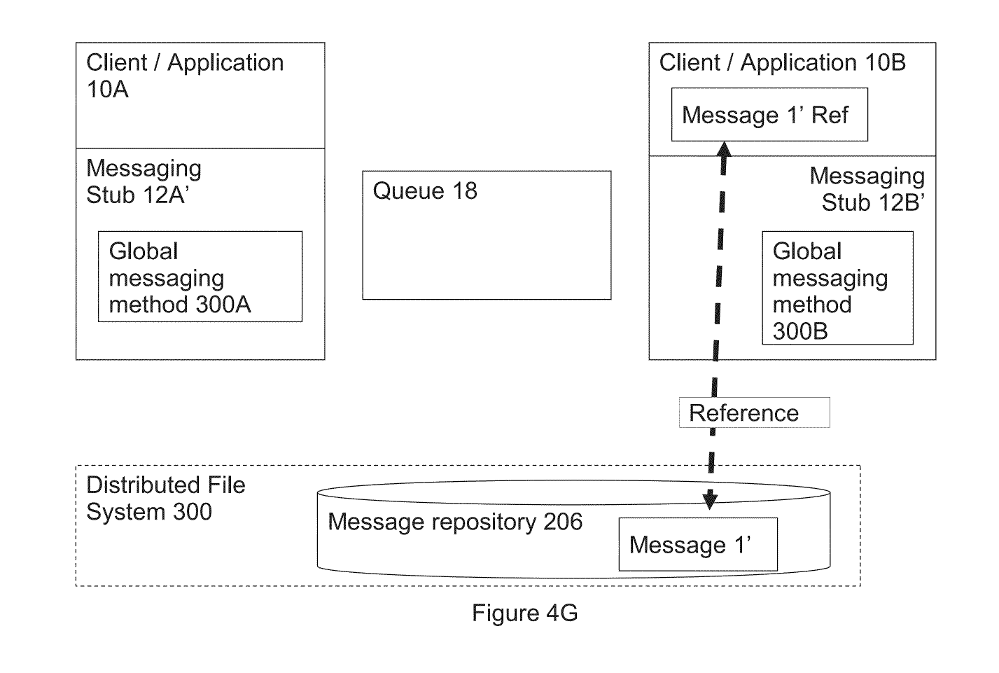

Referring to FIGS. 4A to 4G an example message transfer of the preferred embodiment is described as information flowing between the components.

Referring to FIG. 4A, a straight arrow labeled ‘PUT’ represents a ‘PUT’ call from Application 10A to messaging stub 12A′ for initiation of global messaging method 300 by a producer application.

Referring to FIG. 4B, a curving arrow labeled step 302 and a box labeled Message 1′ represent producer messaging stub 12A′ writing a message to repository 305 in distributed file system 300.

Referring to FIG. 4C, a straight arrow labeled Reference represents the returned of a reference from the distributed file system 300 to messaging stub 12A.

Referring to FIG. 4D, a curving arrow labeled step 304 and a box labeled Message 1′ Ref represent the producer messaging stub writing a reference to the messaging engine. A dotted arrow between Message 1′ Ref and Message 1′ represents the relationship between these entities.

Referring to FIG. 4E, a straight arrow labeled Step 306 represents the messaging engine forwarding the references (Message 1 Ref) to the consumer application stub 12B′.

Referring to FIG. 4F, a straight arrow labeled Step 308 and a box labeled Message 1′ Ref represent the consumer messaging stub reading the message reference and presenting the message to the consumer application.

Referring to FIG. 4G, the message in queue 18 has been removed but this is not essential. The consumer application can access message in distributed file without reference to the message system.

Further embodiments of the invention are now described. It will be clear to one of ordinary skill in the art that all or part of the method of the preferred embodiment may suitably and usefully be embodied in additional logic apparatus or additional logic apparatuses, comprising logic elements arranged to perform the steps of the method and that such logic elements may comprise additional hardware components, firmware components or a combination thereof.

It will be equally clear to one of skill in the art that some or all of the functional components of the preferred embodiment may suitably be embodied in alternative logic apparatus or apparatuses comprising logic elements to perform equivalent functionality using equivalent method steps, and that such logic elements may comprise components such as logic gates in, for example a programmable logic array or application-specific integrated circuit. Such logic elements may further be embodied in enabling elements for temporarily or permanently establishing logic structures in such an array or circuit using, for example, a virtual hardware descriptor language, which may be stored and transmitted using fixed or transmittable carrier media.

It will be appreciated that the method and arrangement described above may also suitably be carried out fully or partially in software running on one or more processors (not shown in the figures), and that the software may be provided in the form of one or more computer program elements carried on any suitable data-carrier (also not shown in the figures) such as a magnetic or optical disk or the like. Channels for the transmission of data may likewise comprise storage media of all descriptions as well as signal-carrying media, such as wired or wireless signal-carrying media.

The present invention may further suitably be embodied as a computer program product for use with a computer system. Such an implementation may comprise a series of computer-readable instructions either fixed on a tangible medium, such as a computer readable medium, for example, diskette, CD-ROM, ROM, or hard disk, or transmittable to a computer system, using a modem or other interface device, over either a tangible medium, including but not limited to optical or analogue communications lines, or intangibly using wireless techniques, including but not limited to microwave, infra-red or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infra-red, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

In an alternative, the preferred embodiment of the present invention may be realized in the form of a computer implemented method of deploying a service comprising steps of deploying computer program code operable to, when deployed into a computer infrastructure and executed thereon, cause the computer system to perform all the steps of the method.

In a further alternative, the preferred embodiment of the present invention may be realized in the form of a data carrier having functional data thereon, said functional data comprising functional computer data structures to, when loaded into a computer system and operated upon thereby, enable said computer system to perform all the steps of the method.

It will be clear to one skilled in the art that many improvements and modifications can be made to the foregoing exemplary embodiment without departing from the scope of the present invention.

What is claimed is:

1. A method for managing persistent messages between a message producer and a remote message consumer in a computing environment, the method comprising:
writing a message into a shared memory location in a distributed file system by the message producer;
writing an associated message reference into a message queue, wherein the associated message reference pointing to the shared memory location; and
reading the associated message reference from the message queue by the remote message consumer and accessing the message in the distributed file system on receiving a notification of the associated message reference in the message queue.

2. The method of claim 1, further including acknowledging by the remote message consumer that the associated message reference has been received.

3. The method of claim 2, further including removing the associated message reference from the message queue on receipt of the acknowledgement.

4. The method of claim 1, further including saving the message in the shared memory location by the distributed filing system and returning a message reference of the shared memory location for writing into the message queue.

5. The method of claim 1, further including passing the associated message reference synchronously to the remote message consumer, wherein the notification contains the associated message reference.

6. A method for managing persistent messages between a message producer and a remote message consumer in a computing environment, the method comprising:
writing a message into a shared memory location in a distributed file system;
receiving an associated message reference with the shared memory location of the message in the distributed file system;
writing an associated message reference into a message queue; and
reading the associated message reference from the message queue by the remote message consumer thereby accessing the message in the distributed file system thereby access the message in the distributed file system.

7. The method of claim 6, further including acknowledging by the remote message consumer that the associated message reference has been received.

8. The method of claim 7, further including removing the associated message reference from the message queue on receipt of the acknowledgement.

9. The method of claim 6, further including saving the message in the shared memory location by the distributed filing system and returning a message reference of the shared memory location for writing into the message queue.

10. The method of claim 6, further including passing the associated message reference synchronously to the remote message consumer, wherein the notification contains the associated message reference.

11. A system for managing persistent messages between a message producer and remote message consumer in a computing environment, the system comprising:
a messaging platform; and
at least one processor device operable in the computing storage environment and in communication with the messaging platform, wherein the at least one processor device:
writes a message into a shared memory location in a distributed file system by the message producer,
writes an associated message reference into a message queue, wherein the associated message reference pointing to the shared memory location, and
reads the associated message reference from the message queue by the remote message consumer and accessing the message in the distributed file system on receiving a notification of the associated message reference in the message queue.

12. The system of claim 11, wherein the at least one processor device acknowledges by the remote message consumer that the associated message reference has been received.

13. The system of claim 12, wherein the at least one processor device removes the associated message reference from the message queue on receipt of the acknowledgement.

14. The system of claim 11, wherein the at least one processor device saves the message in the shared memory location by the distributed filing system and returning a message reference of the shared memory location for writing into the message queue.

15. The system of claim 11, wherein the at least one processor device passes the associated message reference synchronously to the remote message consumer, wherein the notification contains the associated message reference.

16. A system for managing persistent messages between a message producer and remote message consumer in a computing environment, the system comprising:
a messaging platform; and
at least one processor device operable in the computing storage environment and in communication with the messaging platform, wherein the at least one processor device:
writes a message into a shared memory location in a distributed file system,
receives an associated message reference with the shared memory location of the message in the distributed file system,
writes an associated message reference into a message queue, and
reads the associated message reference from the message queue by the remote message consumer thereby accessing the message in the distributed file system thereby access the message in the distributed file system.

17. The system of claim 16, wherein the at least one processor device acknowledges by the remote message consumer that the associated message reference has been received.

18. The system of claim 17, wherein the at least one processor device removes the associated message reference from the message queue on receipt of the acknowledgement.

19. The system of claim 16, wherein the at least one processor device saves the message in the shared memory location by the distributed filing system and returning a message reference of the shared memory location for writing into the message queue.

20. The system of claim 16, wherein the at least one processor device passes the associated message reference synchronously to the remote message consumer, wherein the notification contains the associated message reference.

21. A computer program product for managing persistent messages between a message producer and remote message consumer in a computing by a processor device, the computer program product comprising a non-transitory computer-readable storage medium having computer-readable program code portions stored therein, the computer-readable program code portions comprising:
a first executable portion that writes a message into a shared memory location in a distributed file system by the message producer;
a second executable portion that writes an associated message reference into a message queue, wherein the associated message reference pointing to the shared memory location; and
a third executable portion that reads the associated message reference from the message queue by the remote message consumer and accessing the message in the distributed file system on receiving a notification of the associated message reference in the message queue.

22. The computer program product of claim 21, further including a fourth executable portion that acknowledges by the remote message consumer that the associated message reference has been received.

23. The computer program product of claim 22, further including a fifth executable portion that removes the associated message reference from the message queue on receipt of the acknowledgement.

24. The computer program product of claim 21, further including a fourth executable portion that saves the message in the shared memory location by the distributed filing system and returning a message reference of the shared memory location for writing into the message queue.

25. The computer program product of claim 21, further including a fourth executable portion that passes the associated message reference synchronously to the remote message consumer, wherein the notification contains the associated message reference.

26. A computer program product for managing persistent messages between a message producer and remote message consumer in a computing by a processor device, the computer program product comprising a non-transitory computer-readable storage medium having computer-readable program code portions stored therein, the computer-readable program code portions comprising:
a first executable portion that writes a message into a shared memory location in a distributed file system;
a second executable portion that receives an associated message reference with the shared memory location of the message in the distributed file system;
a third executable portion that writes an associated message reference into a message queue; and
a fourth executable portion that reads the associated message reference from the message queue by the remote message consumer thereby accessing the message in the distributed file system thereby access the message in the distributed file system.

27. The computer program product of claim 26, further including a fifth executable portion that acknowledges by the remote message consumer that the associated message reference has been received.

28. The computer program product of claim 27, further including a sixth executable portion that removes the associated message reference from the message queue on receipt of the acknowledgement.

29. The computer program product of claim 26, further including a fifth executable portion that saves the message in the shared memory location by the distributed filing system and returning a message reference of the shared memory location for writing into the message queue.

30. The computer program product of claim 26, further including a fifth executable portion that passes the associated message reference synchronously to the remote message consumer, wherein the notification contains the associated message reference.
